(19) United States
(12) Patent Application Publication
(10) Pub. No.: US 2009/0037155 A1
(43) Pub. Date: Feb. 5, 2009

(54) Machine condition monitoring using a flexible monitoring framework

(76) Inventors: Bernhard Glomann, Bayonne, NJ (US); Chao Yuan, Secaucus, NJ (US); Claus Neubauer, Monmouth Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/077,541

(22) Filed: Mar. 20, 2008

Related U.S. Application Data
(60) Provisional application No. 60/911,574, filed on Apr. 13, 2007.

(51) Int. Cl. G06N 3/02; G06F 17/10

(52) U.S. Cl. 703/2; 706/23

(57) ABSTRACT

A flexible framework and a corresponding user interface allow a user to configure a machine condition monitoring system. A user-configurable computation framework offers flexibility in designing the machine condition monitoring system. In this framework, every computation based on machine attributes is represented as an input-output system. A simple computation can be easily defined by specifying the computation type, number of inputs, structure, and parameters. The user can use the determined output attributes of computations as input attributes in other computations. Ultimately, the computations are aggregated by the framework configured by the user to produce an output computation attribute that indicates a machine condition or predicts a machine condition.

This application claims the benefit of U.S. Provisional Application No. 60/911,574 filed Apr. 13, 2007, which is incorporated herein by reference.

### BACKGROUND OF THE INVENTION

The present invention relates generally to machine condition monitoring and more particularly to flexible frameworks for machine condition monitoring.

Machine condition monitoring (MCM) is the process of monitoring one or more parameters of machinery for a significant change in the machine parameter(s) that is indicative of a current or developing condition (e.g., failure, fault, etc.). Such machinery includes rotating and stationary machines, such as turbines, boilers, heat exchangers, etc. Machine parameters of monitored machines may be vibrations, temperatures, friction, electrical usage, power consumption, sound, etc., which may be monitored by appropriate sensors. The output of the sensors may be in the form of and/or be aggregated into a sensor signal or a similar signal.

Generally, a condition is a comparison of the machine parameter to a threshold. For example, a machine attribute may be compared with an equality and/or inequality operator, such as <, =, >, ≠, ≡, ≦, ≧, etc., to a threshold value. A condition signal is a signal based on the machine attributes (e.g., a plurality of machine attributes grouped as a discrete or continuous signal) and a condition signal pattern is a portion (e.g., sub-set) of the condition signal.

Machine condition monitoring systems generally use a number of rules to define the machine parameters (e.g., attributes) to be monitored and to determine critical information (e.g., indicative of a condition change) about those machine parameters. In some cases, hundreds of sensors monitor and/or record these machine parameters. The output of the sensors (e.g., sensor signal, sensor estimate, sensor residue, etc.) may then be used as the input to one or more relations (e.g., rules, networks, filters, etc.). Relations are used to detect and/or predict faults, but must minimize improper indicators of faults (e.g., false alarms).

Machine condition monitoring includes monitoring current system conditions as well as fault prognosis. Fault prognosis in MCM is used to predict the future attributes and/or condition signal of a machine. That is, fault prognosis attempts to determine when a fault condition or other significant machine event will occur.

MCM systems require handling and processing increasing amounts and complexities of data. Input data (e.g., condition signals, sensor data, attributes, machine conditions, etc.) can come from multiple sources and/or can be of various types. In addition, data must be usable in multiple operation modes, such as configuration, training, offline monitoring, and/or online monitoring.

Machine condition monitoring systems use various types of data, such as scalar values, multivariate sensor data, spectral data and images. Most of these data types comprise numerical values that are related to each other in specific ways. For example, data from different sensors correspond to each other by time, image data is arranged in a common coordinate system, etc. However, these conventional machine condition monitoring systems cannot coordinate user-configurable integration of rules, rule bases, and multiple data types for machine condition monitoring and fault detection.

Therefore, alternative methods and apparatus are required to allow flexible frameworks for machine condition monitoring.

### BRIEF SUMMARY OF THE INVENTION

The present invention provides methods of machine condition monitoring and fault detection by creating a user-configurable machine condition monitoring framework.

A flexible framework and a corresponding user interface allow a user to configure a machine condition monitoring system. A user-configurable computation framework offers flexibility in designing the machine condition monitoring system. In this framework, every computation based on machine attributes is represented as an input-output system. A simple computation can be easily defined by specifying the computation type, number of inputs, structure, and parameters. The user can use the determined output attributes of computations as input attributes in other computations. Ultimately, the computations are aggregated by the framework configured by the user to produce an overall output computation attribute that indicates a machine condition or predicts a machine condition.

These and other advantages of the invention will be apparent to those of ordinary skill in the art by reference to the following detailed description and the accompanying drawings.

### BRIEF DESCRIPTION OF THE DRAWINGS

FIG. 1 depicts a machine condition monitoring system according to an embodiment of the present invention;

FIG. 2 depicts components of a user interface according to an embodiment of the present invention;

FIG. 3 depicts components of a user interface according to an embodiment of the present invention;

FIG. 4 depicts components of a user interface according to an embodiment of the present invention;

FIG. 5 is a flowchart of a method of machine condition monitoring according to an embodiment of the present invention; and

FIG. 6 is a schematic drawing of a computer.

### DETAILED DESCRIPTION

The present invention generally provides methods and apparatus for machine condition monitoring using flexible frameworks such as user-configurable interfaces and/or machine condition monitors.

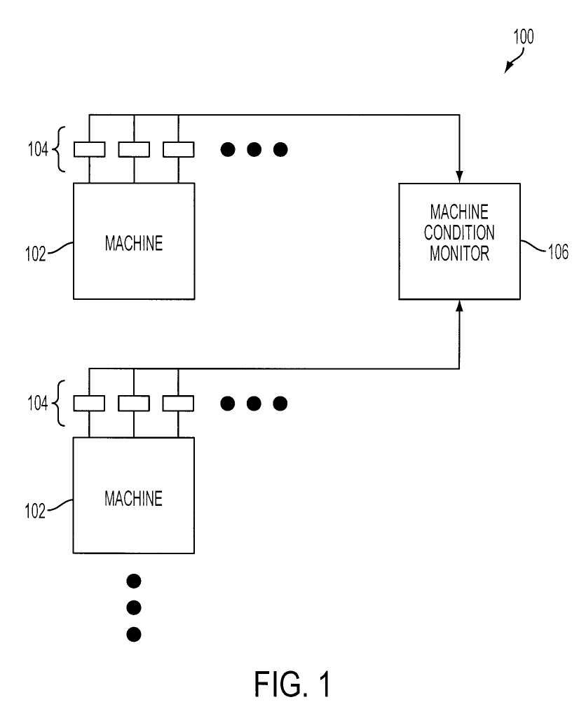

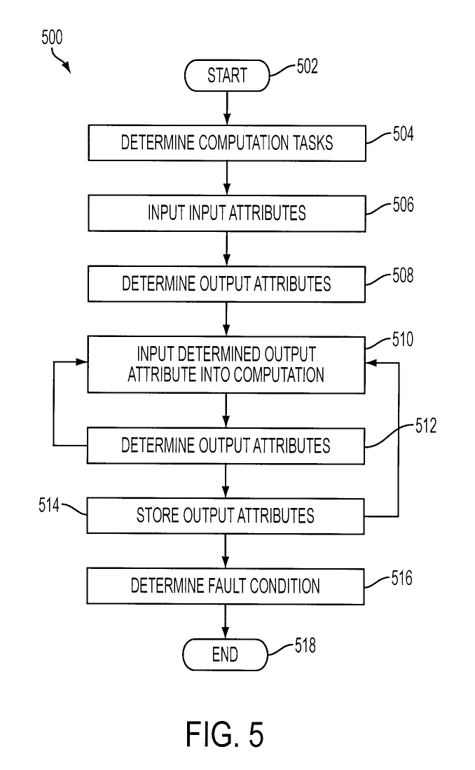

FIG. 1 depicts an embodiment of a machine condition monitoring system 100 according to an embodiment of the present invention. Machine condition monitoring (MCM) system 100 may be used in both the creation of computation and/or monitoring tasks, as described below with respect to method 500 of FIG. 5, and general machine condition monitoring. MCM system 100 monitors one or more machines 102, each having one or more sensors 104. The output of sensors 104 is received at machine condition monitor 106, which provides a flexible framework for manipulating the output of sensors 104 to create complex machine condition monitoring rules, detect machine faults, and/or predict machine faults.

Machines 102 may be any devices or systems that have one or more monitorable machine parameters, which may be monitored by sensors 104. Exemplary machines 102 include rotating and stationary machines, such as turbines, boilers, heat exchangers, etc.

Sensors 104 are any devices which measure quantities and convert the quantities into signals which can be read by an observer and/or by an instrument as is known. Sensors 104 may measure machine parameters of machines 102 such as vibrations, temperatures, friction, electrical usage, power consumption, sound, etc. The output of sensors 104 may be in the form of and/or aggregated into a condition signal composed of one or more attributes (e.g., parameter values).

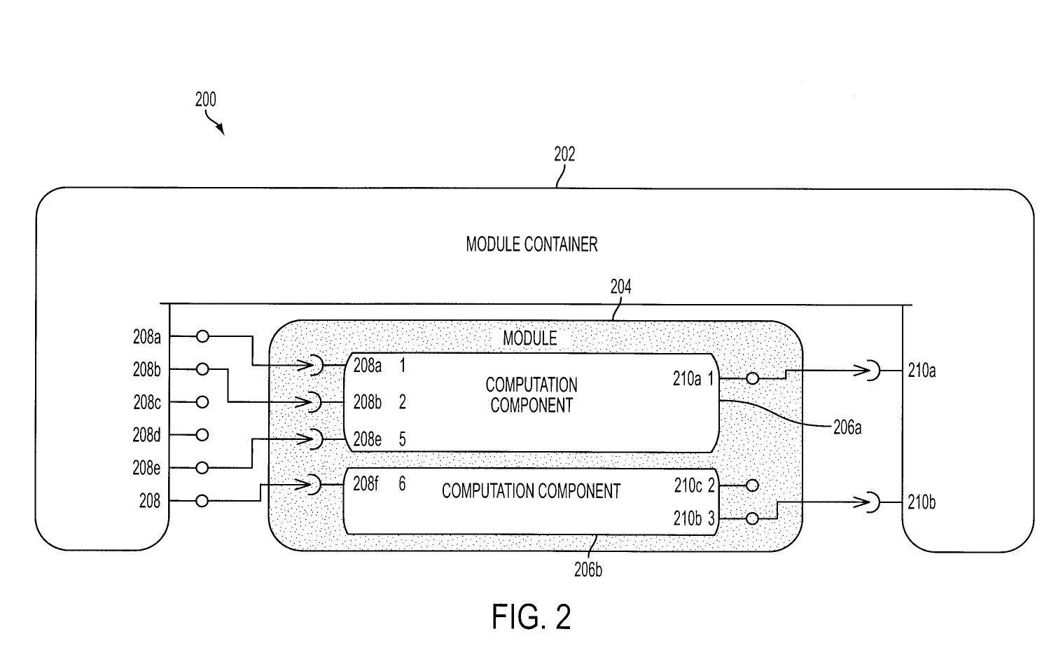

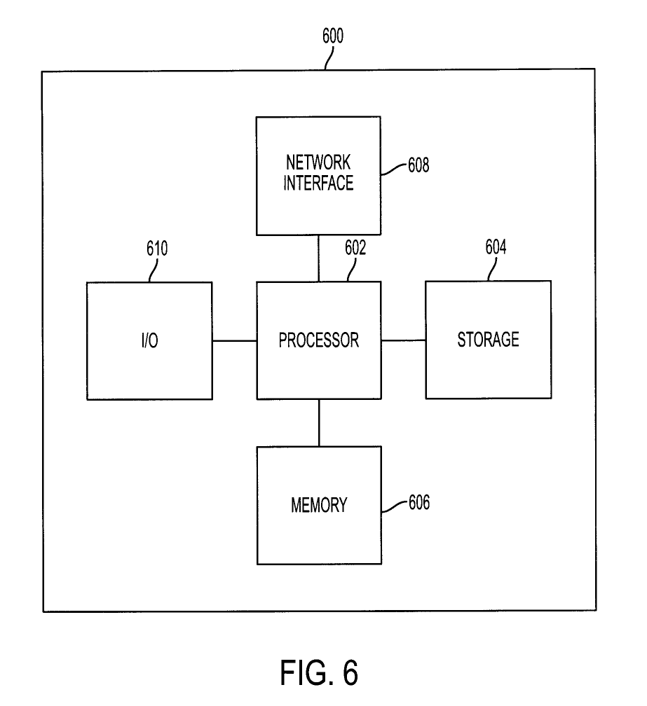

In some embodiments, machine condition monitor 106 may be implemented on and/or in conjunction with one or more computers, such as computer 600 described below with respect to FIG. 6. Machine condition monitor 106 may be configured to provide a user interface (e.g., a software product implemented with a graphical user interface (GUI) or the like). In this way, machine condition monitor 106 presents a unified computation framework that offers more flexibility in machine condition monitoring in machine condition monitoring system 100 as described below in greater detail with respect to FIGS. 2-5.

FIGS. 2-4 depict graphical representations of the underlying logical constructs of machine condition monitor 106. Though depicted in FIGS. 2-4 as components of an interface of machine condition monitor 106, one of skill in the art will recognize that any appropriate implementations means using hardware, software, machine readable instructions, logic, and/or memory may be used as the basis of the flexible framework of machine condition monitor 106. For simplicity of presentation, components of interfaces 200, 300, and 400, of FIGS. 2-4, respectively, that have similar structure and/or function utilize the same and/or similar reference numerals and are functional analogues of each other and their associated descriptions are not repeated. Of course, the various implementations of FIGS. 2-4 are not identical and each interface 200, 300, and 400 should be considered as a unique example of the flexible framework of the present invention.

FIG. 2 depicts components of an interface 200 of machine condition monitor 106. Interface 200 may include a module container 202 that receives machine attributes from sensors 104. These machine attributes and other attributes may be forwarded to one or more modules 204 as input attributes. Each module 204 may have one or more computation components 206a, 206b. The input attributes of module 204 may be input to one or more computation components 206a, 206b and/or other modules 204 and the outputs of modules 204 and/or computation components 206a, 206b may be input to other of modules 204 and/or computation components 206a, 206b as described below with respect to method 500 of FIG. 5.

Module container 202 may be any appropriate storage and/or memory, such as storage 604 and/or memory 606 discussed below with respect to FIG. 6, capable of storing attributes, such as input attributes 208a, 208b, 208c, 208d, 208e, 208f and output attributes 210a, 210b, and providing information about such attributes 208a-f and 210a-b to one or more modules 204. Herein, attributes are information or data indicative of a machine condition and/or a component of a machine condition. For example, a machine attribute may be a sensor value (e.g., a representation of a measurement determined by a sensor 104), an observation value, or a value representative of some measured aspect of a machine and computed attributes may be values derived from machine or other attributes. Computed attributes (e.g., output attributes 210a-b) may be derived (e.g., determined, calculated, etc.) using modules 204, computation components 206a, 206b, and/or by any other appropriate methods or apparatus.

Modules 204 are user-configurable components of interface 200. In other words, modules 204 are representations of algorithms and/or processing steps to be applied to one or more attributes 208a-f and such algorithms and/or processing steps may be described, defined, and/or created by a user of machine condition monitor 106 (e.g., via I/O 610 of FIG. 6, described below).

Each module 204 may be composed of one or more computation components 206a, 206b. Similar to modules 204, computation components 206a, 206b are representations of processes and/or computations to be performed on input attributes 208a-f from module container 202. Such processes and/or computations may be equations, functions, filters, rules, networks, etc.

Herein, equations refer to mathematical operations to be performed on attributes. For example, an equation

$$A = \frac{( {attribute}_{1} + {attribute}_{2} + 10 )}{3}$$

may refer to a value A (e.g., a computed attribute A) that is equal to the average of the attributes of two sensors 104 and a constant 10. Equations may also include standard functions such as cosine, exponential, etc. and can be built recursively. In other words, each operand and/or argument of an operation and/or function can itself be given by another operation.

Functions refer to mathematical formulae that cannot be simply described by the above equations. Exemplary functions include multiple layer perceptron neural networks, support vector machines, and Bayesian networks. For example, a neural network can be represented as y=NN(attribute₁, attribute₂, attribute₃), which indicates this neural network uses attributes of three sensors as inputs and outputs a computed attribute value y. Other models, including Kalman filters and the like, that describe temporal time behavior of a system may also be considered as functions. For example, the Kalman filter x=Kalman_filter(attribute₁) uses the attribute of a sensor (e.g., its observation value, etc.) as an input and outputs the filtered output attribute value x.

Rules used to provide diagnosis and prognosis decisions as is known. In general, simple rules are constructed as indicative conditional logical operations (e.g., if—then statements). The input of a rule, the “if”, is a condition as described above (e.g., if machine parameter A>threshold B) and the output of the rule, the “then”, is a fault (e.g., then fault type 1). That is, the premise and the conclusion specify the condition and the decision of a rule, respectively. Exemplary rule types include comparison rules (e.g., if attribute₁>100, then fault type 1, etc.), logic rules (e.g., if attribute₁>100 AND attribute₂ <50, then fault type 2, etc.), fuzzy rules (e.g., if attribute₁ is too high, then fault type 3, etc.), and special rules (e.g., other types of rules designed for particular applications).

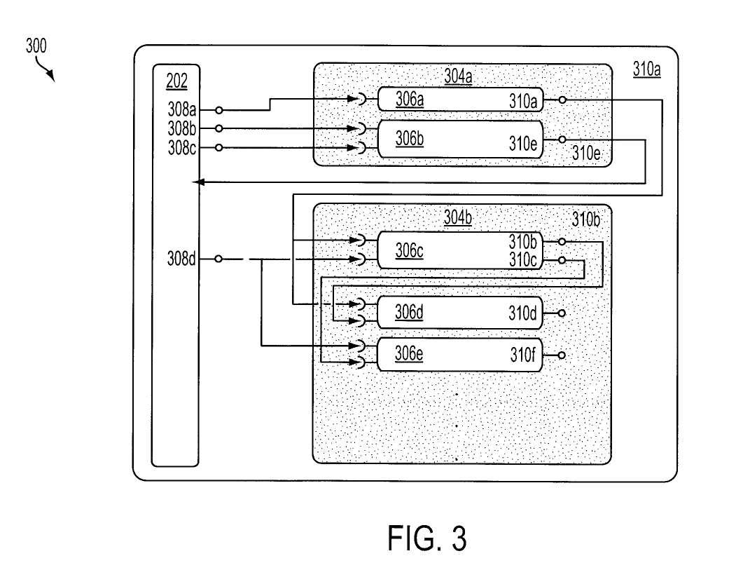

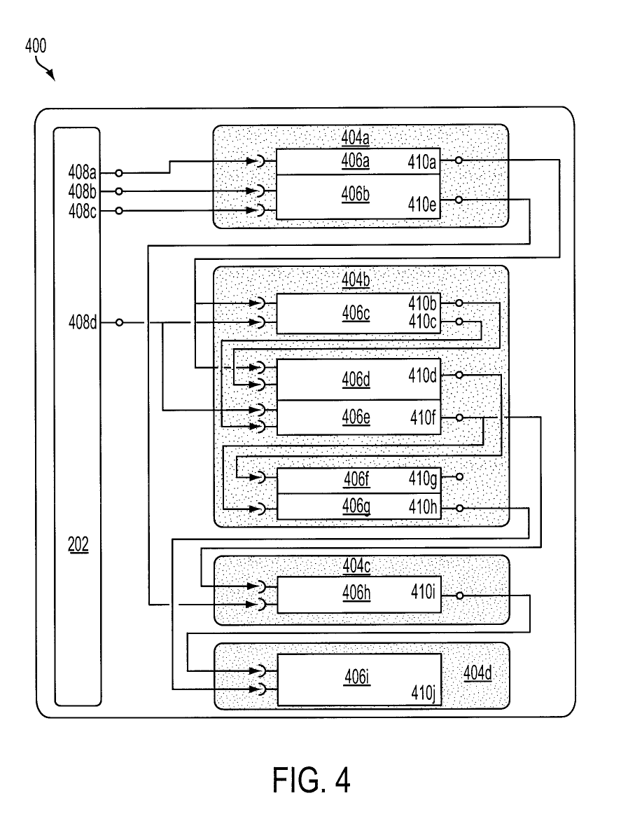

Though described herein with respect to exemplary computations including equations, functions, filters, networks, and rules, any appropriate manipulation, computation, and/or handling of attributes may be utilized in machine condition monitoring system 100 and interface 200. Likewise, though described in FIG. 2 as a single module 204 with two computation components 206a, 206b, any appropriate number and/or arrangement of modules 204 and/or computation components 206a, 206b may be used, as shown in FIGS. 3 and 4 below.

The final output and/or any intermediate outputs (e.g., output attributes 210a, 210b, etc.) of modules and/or computations may be displayed and/or otherwise output to a user (e.g., via I/O 610 of FIG. 6 below). In this way, the result of a module and/or a computation may be a machine condition, such as an indication of a fault and/or a prediction of a future fault.

In operation, module container 202 sends input attributes 208a, 208b, and 208e to computation component 206a of module 204. Computation component 206a performs some computation, as described above, using one or more of input attributes 208a, 208b, and 208e and produces output attribute 210a, which may be sent to and/or stored at module container 202. In this way, output attribute 210a may be used as an input attribute to the same or another module 204 and/or computation component 206.

Module container 202 also sends input attribute 208f to computation component 206b of module 204. Computation component 206b performs some computation using input attributes 208f and produces output attribute 210b, which may be sent to and/or stored at module container 202. In this way, output attribute 210b may be used as an input attribute to another module 204 and/or computation component 206.

FIG. 3 depicts components of an interface 300 of machine condition monitor 106. Interface 300 may be similar to interface 200 of FIG. 2 and may include a module container 202 that receives machine attributes from sensors 104 of FIG. 1. These machine attributes and other attributes may be forwarded to one or more modules 304a, 304b as input attributes. Each module 304a, 304b may have one or more computation components 306a, 306b, 306c, 306d, 306e. The input attributes of modules 304a, 304b may be input to one or more computation components 306a, 306b, 306c, 306d, 306e and/or other modules 304 and the outputs of modules 304a, 304b and/or computation components 306a, 306b, 306c, 306d, 306e may be input to other of modules 304 and/or computation components 306 as described below with respect to method 500 of FIG. 5.

In operation, module container 202 sends input attribute 308a to computation component 306a of module 304a. Computation component 306a performs some computation, as described above, using input attribute 308a and produces output attribute 310a, which may be sent to computation components 306c and 306d of module 304b. Output attribute 310a may then be used as an input attribute for computation components 306c and 306d of module 304b. Computation component 306c performs some computation, as described above, using output attribute 310a as an input along with input attribute 308d and produces output attributes 310b and 310c. Output attribute 310b may be sent to computation component 306d of module 304b and output attribute 310c may be sent to computation component 306e of module 304b. Computation component 306d performs some computation, as described above, using output attribute 310b as an input along with output attribute 310a and produces output attribute 310d, which may be sent to and/or stored at module container 202. In this way, output attributes may be used as an input attributes to another module 304 and/or computation component 306. As described herein, any appropriate output attribute may be used as an input attribute to a computation. Accordingly, the particular input/output workflow of input attributes 308b, 308c, 308d and output attributes 310c, 310e, 310f are not described in further detail.

FIG. 4 depicts components of an interface 400 of machine condition monitor 106. Interface 400 may be similar to interfaces 200 and 300 of FIGS. 2 and 3, respectively, and may include a module container 202 that receives machine attributes from sensors 104 of FIG. 1. These machine attributes and other attributes may be forwarded to one or more modules 404a, 404b, 404c, 404d as input attributes. Each module 404a-d may have one or more computation components 406a, 406b, 406c, 406d, 406e, 406f, 406g, 406h, 406i. The input attributes of modules 404a-d may be input to one or more computation components 406a-i and/or other modules 404 and the outputs of modules 404a-d and/or computation components 406a-i may be input to other of modules 404 and/or computation components 306 as described below with respect to method 500 of FIG. 5.

In operation, module container 202 sends input attribute 408a to computation component 406a of module 404a. Computation component 406a performs some computation, as described above, using input attribute 408a and produces output attribute 410a, which may be sent to computation components 406c and 406d of module 404b. Output attribute 410a may then be used as an input attribute for computation components 406c and 406d of module 404b. Computation component 406c performs some computation, as described above, using output attribute 410a as an input along with input attribute 408d and produces output attributes 410b and 410c. Output attribute 410b may be sent to computation component 406d of module 404b and output attribute 410c may be sent to computation component 406e of module 404b. Computation component 406d performs some computation, as described above, using output attribute 410b as an input along with output attribute 410a and produces output attribute 410d, which may be sent to computation component 406f and so on. In this way, output attributes may be used as an input attributes to another module 404 and/or computation component 406. As described herein, any appropriate output attribute may be used as an input attribute to a computation. Accordingly, the particular input/output workflow of input attributes 408b, 408c, 408d and output attributes 410c, 410e, 410f, 410g, 410h, 410i, 410j are not described in further detail.

In the interface of machine condition monitor 106, every computation of computation components 206, 306, 406 (e.g., equations, functions, filters, networks, rules, etc.) is viewed as an input-output system. Modules 204, 304, 404 may allow the user to define any number of computation components 206, 306, 406 and represent each computation component 206, 306, 406 as a separate computation. Each of these computation components 206, 306, 406 would have as many input attributes as variables used in the computation, and one or more outputs representing the result (e.g., the output attribute). In general, each computation component 206, 306, 406 can be computed independently, though, as shown above, a computation component 206, 306, 406 may use the result of another computation component 206, 306, 406 as one of its inputs. In such cases the flexible framework (e.g., interfaces 200, 300, 400 of machine condition monitor 106) will automatically invoke the necessary computation component 206, 306, 406 to provide the input attribute value needed for evaluation.

A simple computation can be easily defined by specifying the type, number of inputs, structure, and parameters. These computations are managed by modules 204, 304, 404. Thus, the flexible framework (e.g., interfaces 200, 300, 400 of machine condition monitor 106) can be easily extended with new types of modules 204, 304, 404 and/or computation components 206, 306, 406 and each module 204, 304, 404 type can define its own computations (e.g., determine appropriate computation components 206, 306, 406) and appropriate manners of managing and/or parameterizing them. As shown above, the framework provides common functionality, such as managing dependencies between modules, invoking computations, and caching (e.g., storing) their results.

FIG. 5 is a flowchart of a method 500 of machine condition monitoring. In at least one embodiment, method steps of method 500 may be used to detect and/or predict fault conditions. Machine condition monitoring system 100, specifically machine condition monitor 106 may be used to detect and/or predict faults in machines 102. The method begins at step 502.

In step 504, computation tasks are determined. Computation tasks may be multiple computations determined by a user, such as through interfaces 200, 300, 400 of FIGS. 2-4, and/or as needed by other computation tasks, as described above. Computation tasks may be represented as computation modules 204, 304, 404 and/or computation components 206, 306, 406. That is, a user and/or machine condition monitor 106 may determine one or more types of computations to perform and/or desired results (e.g., detect a certain fault type, predict a fault time, etc.) and using interfaces 200, 300, 400, may construct a fault detection and/or prediction algorithm or system.

In determining a computation task, it may be necessary to specify the number of input attributes and/or determine necessary parameters of the computation task. For some simple computations, the number of inputs is predetermined based on the computation type. For example, in a comparison rule such as “<”, there must be two inputs. However, for a sum equation, there can be as many inputs as desired by the user and/or required by previous and/or subsequent computations.

Necessary parameters are determined for each computation component 206, 306, 406 and/or module 204, 304, 404. For example, to define a fuzzy rule such as “If temperature is very high, then failure A”, a membership function and/or a lookup table is a necessary parameter. In some instances, the parameters need to be estimated from training data. In some embodiments, to define a multiple layer neural network, the number of layers must be specified, the number of neurons in each layer and the type of kernels must be specified, and the weights of this network may be obtained in training and/or are predetermined.

In step 506, input attributes are input into the determined computation tasks. As described above with respect to FIGS. 2-4, the computation tasks may be computation components 206, 306, 406. Accordingly, input attributes may be machine or other attributes from module container 202 and/or computed attributes from one or more other computation components 206, 306, 406.

Based on the input attributes from step 506 and the computation tasks (e.g., computation components 206, 306, 406) from step 504, one or more output attributes are determined in step 508. As discussed above with respect to FIGS. 2-4, each computation component 206, 306, 406 has one or more outputs and will output an output attribute based on the input attributes.

In step 510, output attributes from step 508 are input into determined computation tasks. In some embodiments, a user may specify one or more output attributes from one or more of the determined computation tasks to be used as input attributes in other computation tasks. In the same or alternative embodiments, the flexible framework of machine condition monitor 106 will recognize which attributes are necessary as input attributes to a determined (e.g., user defined, selected, etc.) computation task and will select and/or incorporate appropriate output attributes and/or computation tasks to procure the necessary input attributes.

Based on the output attributes from step 510 used as input attributes to the determined computation tasks (e.g., computation components 206, 306, 406) from step 504, one or more additional output attributes are determined in step 512.

Optionally, in step 514, one or more of the output attributes from steps 508 and/or 512 are stored (e.g., cached). For example, a neural network module 204, 304, 404 would have one computation component 206, 306, 406 to represent the whole neural network, but the module 204, 304, 404 may allow the user to configure the number of input attributes and number of output attributes of the network, as well as other parameters. The whole network may be represented as one computation component 206, 306, 406 because each of the outputs depends on all of the inputs. As such, changing the value of just one of the inputs may change the values of all of the outputs, and to compute just one of the outputs requires evaluating all of the inputs and computing most of the network's nodes. In other words, computing the value of one output requires about as much effort as computing all of the outputs. In such cases, representing all these outputs as one computation component 206, 306, 406 allows the framework to improve performance by automatically caching all output attributes. For example, when the value of one output attribute of a neural network needs to be computed (e.g., to provide an input for a subsequent computation component 206, 306, 406, to display values to the user as in step 516, etc.), the computation component 206, 306, 406 will compute the output attribute not only for the currently needed output, but also for the remaining output attributes, and the framework will store all the output attribute values in a cache (e.g., storage 604 and/or memory 606 of computer 600, below). Generally, at least some of the other output attribute values may be needed presently, so then they can just be taken from the cache.

In step 516, a fault condition is determined. The fault condition may be an indication of a current and/or impending fault (e.g., a prediction of a fault). The fault condition may be an output attribute as determined in step 512 or may be an indication of a fault or a prediction of a fault based at least in part on one or more output attributes from steps 508 and/or 512.

Users may define any appropriate input/output relationship using computation components 206, 306, 406 and/or modules 204, 304, 404. That is, there is a user-configurable interface 200, 300, 400 of machine condition monitor 106 in MCM system 100. The interface may allow a user to connect computation components 206, 306, 406 and/or modules 204, 304, 404 by using the outputs from one computation component 206, 306, 406 and/or module 204, 304, 404 as inputs to another module. The user-configurable framework automatically tracks dependencies between computation components 206, 306, 406 and modules 204, 304, 404. These dependencies are used by the flexible framework to determine which computation tasks from step 504 need to be invoked in which order to get the output attribute value for a particular input attribute value, as in steps 508, 512, and/or 516. Further, machine condition monitor 106 ensures referential integrity by determining whether outputs of a computation component 206, 306, 406 and/or module 204, 304, 404 are still referenced before removing the computation component 206, 306, 406 and/or module 204, 304, 404. In this way, computation components 206, 306, 406 and/or modules 204, 304, 404 may be notified about changes affecting their inputs and may determine new input attributes and/or indicate the dependency fault.

The method ends at step 518.

FIG. 6 is a schematic drawing of a computer 600 according to an embodiment of the invention. Computer 600 may be used in conjunction with and/or may perform the functions of machine condition monitoring system 100 and/or the method steps of method 500.

Computer 600 contains a processor 602 that controls the overall operation of the computer 600 by executing computer program instructions, which define such operation. The computer program instructions may be stored in a storage device 604 (e.g., magnetic disk, database, etc.) and loaded into memory 606 when execution of the computer program instructions is desired. Thus, applications for performing the herein-described method steps, such as computation task and/or module creation, fault detection, and machine condition monitoring, in method 500 are defined by the computer program instructions stored in the memory 606 and/or storage 604 and controlled by the processor 602 executing the computer program instructions. The computer 600 may also include one or more network interfaces 608 for communicating with other devices via a network. The computer 600 also includes input/output devices 610 (e.g., display, keyboard, mouse, speakers, buttons, etc.) that enable user interaction with the computer 600. Computer 600 and/or processor 602 may include one or more central processing units, read only memory (ROM) devices and/or random access memory (RAM) devices. One skilled in the art will recognize that an implementation of an actual controller could contain other components as well, and that the controller of FIG. 6 is a high level representation of some of the components of such a controller for illustrative purposes.

According to some embodiments of the present invention, instructions of a program (e.g., controller software) may be read into memory 606, such as from a ROM device to a RAM device or from a LAN adapter to a RAM device. Execution of sequences of the instructions in the program may cause the computer 600 to perform one or more of the method steps described herein, such as those described above with respect to method 500. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory 606 may store the software for the computer 600, which may be adapted to execute the software program and thereby operate in accordance with the present invention and particularly in accordance with the methods described in detail above. However, it would be understood by one of ordinary skill in the art that the invention as described herein could be implemented in many different ways using a wide range of programming techniques as well as general purpose hardware sub-systems or dedicated controllers.

Such programs may be stored in a compressed, uncompiled, and/or encrypted format. The programs furthermore may include program elements that may be generally useful, such as an operating system, a database management system, and device drivers for allowing the controller to interface with computer peripheral devices, and other equipment/components. Appropriate general purpose program elements are known to those skilled in the art, and need not be described in detail herein.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of machine condition monitoring comprising:
determining a plurality of computations;
inputting at least one input attribute into each of the plurality of computations;
determining at least one output attribute for each of the plurality of computations;
inputting at least one of the at least one output attributes as a computed input attribute into at least one of the plurality of computations; and
determining a computation output attribute based at least in part on the computed input attribute.

2. The method of claim 1 wherein the computation output attribute is an indication of a machine condition.

3. The method of claim 2 further comprising:
displaying the indication of the machine condition to a user.

4. The method of claim 1 wherein at least one of the plurality of computations are determined by a user utilizing a user interface.

5. The method of claim 1 wherein determining at least one output attribute for each of the plurality of computations comprises determining a plurality of output attributes for one of the plurality of computations and further comprising:
providing at least one output attribute of the plurality of output attributes to a user; and
storing the remaining output attributes.

6. The method of claim 5 wherein the one of the plurality of computations is a neural network.

7. A method of machine condition monitoring comprising:
determining a first computation task;
inputting at least one input attribute for the first computation task;
determining a plurality of output attributes of the first computation task based at least in part on the input at least one input attribute;
outputting to a user at least one output attribute of the plurality of output attributes; and
storing the remaining output attributes.

8. The method of claim 7 further comprising:
inputting at least one of the stored remaining output attributes as a computed input attribute for a second computation task; and
determining a computation output attribute based at least in part on the computed input attribute.

9. The method of claim 7 wherein outputting to a user at least one output attribute of the plurality of output attributes comprises:
displaying the at least one output attribute.

10. The method of claim 9 wherein displaying the at least one output attribute comprises:
displaying a machine condition to the user.

11. A system for machine condition monitoring comprising:
means for determining a plurality of computation components;
means for inputting at least one input attribute into each of the plurality of computation components;
means for determining at least one output attribute for each of the plurality of computation components;
means for inputting at least one of the at least one output attributes as a computed input attribute into at least one of the plurality of computation components; and
means for determining a computation output attribute based at least in part on the computed input attribute.

12. The system of claim 11 wherein the computation output attribute is an indication of a machine condition.

13. The system of claim 12 further comprising:
means for displaying the indication of the machine condition to a user.

14. The system of claim 11 further comprising a user interface configured to allow a user to determine at least one of the plurality of computation components.

15. The system of claim 11 wherein the means for determining at least one output attribute for each of the plurality of computation components comprises means for determining a plurality of output attributes for one of the plurality of computation components and further comprising:
means for providing at least one output attribute of the plurality of output attributes to a user; and
means for storing the remaining output attributes.

16. The method of claim 15 wherein the one of the plurality of computation components employs a neural network.

17. A machine readable medium having program instructions stored thereon, the instructions capable of execution by a processor and defining the steps of:
determining a plurality of computations;
inputting at least one input attribute into each of the plurality of computations;
determining at least one output attribute for each of the plurality of computations;
inputting at least one of the at least one output attributes as a computed input attribute into at least one of the plurality of computations; and
determining a computation output attribute based at least in part on the computed input attribute.

18. The machine readable medium of claim 17 wherein the computation output attribute is an indication of a machine condition.

19. The machine readable medium of claim 18 wherein the instructions further define the step of:
displaying the indication of the machine condition to a user.

20. The machine readable medium of claim 17 wherein the instructions further define the step of:
receiving at least one of the plurality of computations from a user interface.

21. The machine readable medium of claim 17 wherein the instructions for determining at least one output attribute for each of the plurality of computations comprises instructions for determining a plurality of output attributes for one of the plurality of computations and further defines the steps of:
providing at least one output attribute of the plurality of output attributes to a user; and
storing the remaining output attributes.

22. The machine readable medium of claim 21 wherein the one of the plurality of computations is a neural network.
